(19) United States
(12) Patent Application Publication
(10) Pub. No.: US 2014/0097318 A1
(43) Pub. Date: Apr. 10, 2014

(54) LINEAR BEARING

(71) Applicant: QUALITY VISION INTERNATIONAL, INC., Rochester, NY (US)

(72) Inventor: Frederick D. Schwab, Atlanta, NY (US)

(73) Assignee: Quality Vision International, Inc., Rochester, NY (US)

(21) Appl. No.: 13/648,561

(22) Filed: Oct. 10, 2012

(51) Int. Cl. F16C 33/58; F16M 13/00

(52) U.S. Cl. 248/430; 384/9

(57) ABSTRACT

A bearing race arrangement on a composite structure having a first coefficient of thermal expansion includes a recess formed in a surface of the composite structure for receiving a race element, at least one bearing race element disposed in the recess, the bearing race element having a coefficient of thermal expansion different from the coefficient of thermal expansion of the composite structure and a retainer securing the bearing race element to composite structure, within the recess and allowing for longitudinal expansion of the race element without creating stress on the composite structure.

### CROSS-REFERENCE TO RELATED APPLICATIONS

None.

### STATEMENT REGARDING FEDERALLY SPONSORED RESEARCH OR DEVELOPMENT

None.

REFERENCE TO A “SEQUENCE LISTING”

Not applicable.

### BACKGROUND OF THE INVENTION

1. Field of the Invention

This invention relates generally to movable supports using linear bearings and more particularly to a linear bearing arrangement associated with components of such supports with differing coefficients of thermal expansion from the bearing elements that reduces deformation caused by changes in temperature of the components.

2. Description of Related Art

Machines such as coordinate measurement machines often have components or elements such as platforms that are movable with respect to a support structure. Composite materials such as carbon fiber materials are lighter and often stronger than steel or other metals that have typically been used in such applications and there are benefits to using them. Unfortunately, composite materials are not well-suited to forming bearings and bearing surfaces or races for allowing precision movement of platforms with respect to their support structures. Steel bearings and associated races or tracks provide the necessary durability and precision but steel has a higher coefficient of thermal expansion than composite materials such as carbon fiber and this creates problems when attaching steel bearing components to composite components. When a steel bearing race having a higher coefficient of thermal expansion than a composite body is rigidly attached to the body and the combination is heated, the steel will expand more than the composite material, exert a stress on the composite material and cause the composite material to deform. FIG. 1 illustrates the deformation of a composite beam having a steel bearing race attached to one surface thereto when the temperature of the combination is increased by 3° C. FIG. 1A is an illustration of the beam itself and FIG. 1B is a graphical representation of its deformation. In an attempt to reduce this deformation, it has been suggested to attach a compensating steel element to the beam in a position opposite the steel bearing race as shown in FIG. 2. FIGS. 2A and 2B illustrate this approach. FIG. 2B shows that the composite beam with a fixed bearing race and a compensating structure still deforms though in a more complex manner than the arrangement of FIG. 1.

### BRIEF SUMMARY OF THE INVENTION

Briefly stated and in accordance with one aspect of the invention a bearing race arrangement on a composite structure having a first coefficient of thermal expansion includes an optional recess formed in a surface of the composite structure for receiving a race element, at least one bearing race element disposed in the recess or on the surface, the bearing race element having a coefficient of thermal expansion different from the coefficient of thermal expansion of the composite structure and a retainer securing the bearing race element to composite structure, within the recess and allowing for longitudinal expansion of the race element without creating stress on the composite structure.

While an embodiment with the bearing race element positioned within a recess is illustrated, it will be understood that different arrangements, for example attaching the bearing race element to a flat surface of the composite structure could also be used.

In accordance with another aspect of the invention, the recess is a longitudinal recess.

In accordance with another aspect of the invention the bearing race element comprises a pair of parallel rods.

In accordance with yet another aspect of the invention each rod the pair of parallel rods has a generally circular cross section.

In accordance with a still further aspect of the invention each of the parallel rods has a diameter less than half the width of the recess.

### BRIEF DESCRIPTION OF THE SEVERAL VIEWS OF THE DRAWINGS

The novel aspects of the invention are set forth with particularity in the appended claims. The invention itself may be more readily understood by reference to the following detailed description of presently preferred embodiments of the invention taken in conjunction with the accompanying drawings in which:

FIG. 1A is a diagrammatic view of a composite structure having an element with a greater coefficient of thermal expansion than the composite structure rigidly attached to a surface of the structure.

FIG. 1B is a diagrammatic view showing the strain on the composite structure caused by the bearing race having a higher coefficient of thermal expansion than the beam.

FIG. 2A is a diagrammatic view of a composite structure having a simulated bearing race on one surface and a compensating structure on an opposite surface.

FIG. 2B is a diagrammatic view showing the strain on the composite structure of FIG. 2A.

FIG. 3 is a perspective view of a composite beam with a bearing race and a slide member mounted thereon in accordance with this invention

FIG. 4 is a cross-section taken along lines 3-3 of FIG. 3.

FIG. 5 is an enlarged fragment, partly in section, of a corner of the beam showing a bearing race in accordance with the invention.

FIG. 6 is an enlarged fragment, partly in section of the corner of the beam in accordance with another embodiment of the invention.

FIG. 7 is an enlarged fragment, partly in section of the corner of the beam in accordance with still another embodiment of the invention.

FIG. 8 is an enlarged fragment, partly in section, of a clip for securing a bearing race to the beam in accordance with an embodiment of this invention.

### DETAILED DESCRIPTION OF THE INVENTION

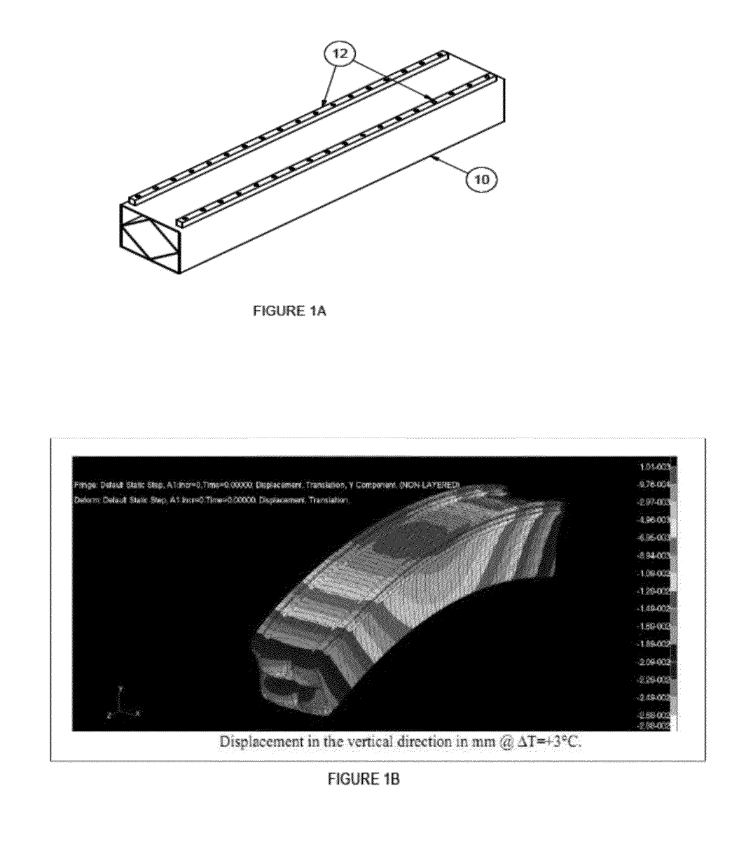

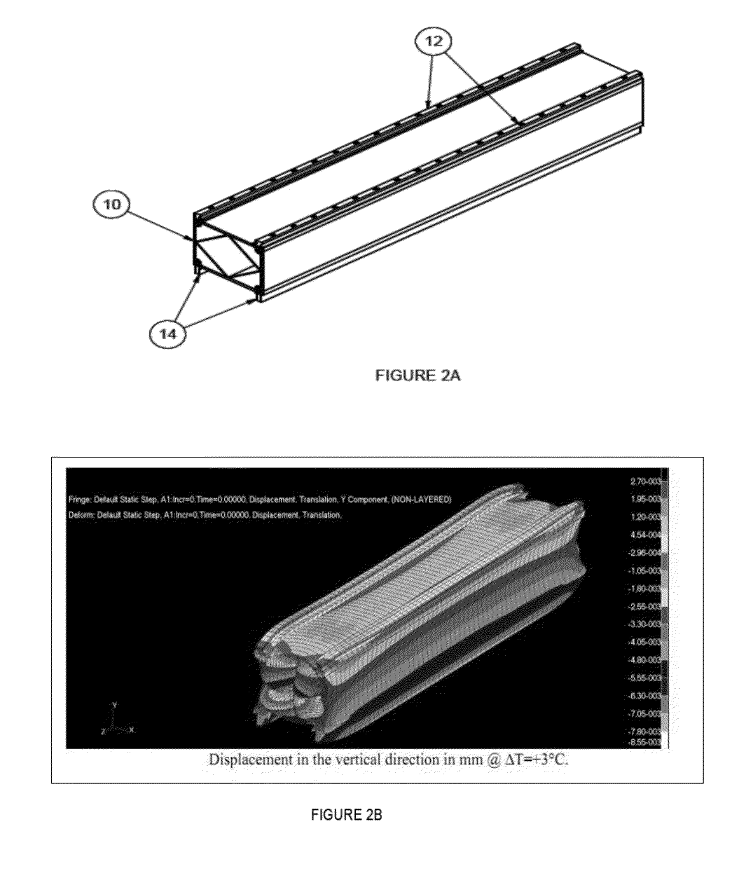

Composite transversal beams of the type with which this invention is concerned have coefficients of thermal expansion that differ from those of metal, preferably steel parts such as bearing races that are attached to the beams to support movable platforms. The difference in the coefficients of thermal expansion cause the beam to deflect when the temperature changes. FIG. 1A shows a beam 10 of the type with which this invention is concerned that has rigid metal elements 12 simulating a bearing race attached length wise to the corners thereof and is subjected to a temperature change of approximately 3° C. As the metal elements expand to a greater extent than the composite beam, the beam is warped as shown in FIG. 1B. The amount of warping is exaggerated for clarity. Warping causes a number of problems including possible binding of the bearings and moreover creates inaccuracies in measurement. One approach to minimizing the strain on a composite beam caused by metal elements such as bearing races attached thereto has been to attach compensating element 14 to an opposite surface of the beam. FIGS. 2A and 2B show the strain on a beam like that of FIG. 1A but with a compensating element attached to a surface of the beam opposite the simulated bearing race, with the same 3° C. temperature change. The deformation of the beam is more complex but still undesirable. In addition this method adds additional mass to the beam structure which negates a portion of the benefit of a composite beams low mass.

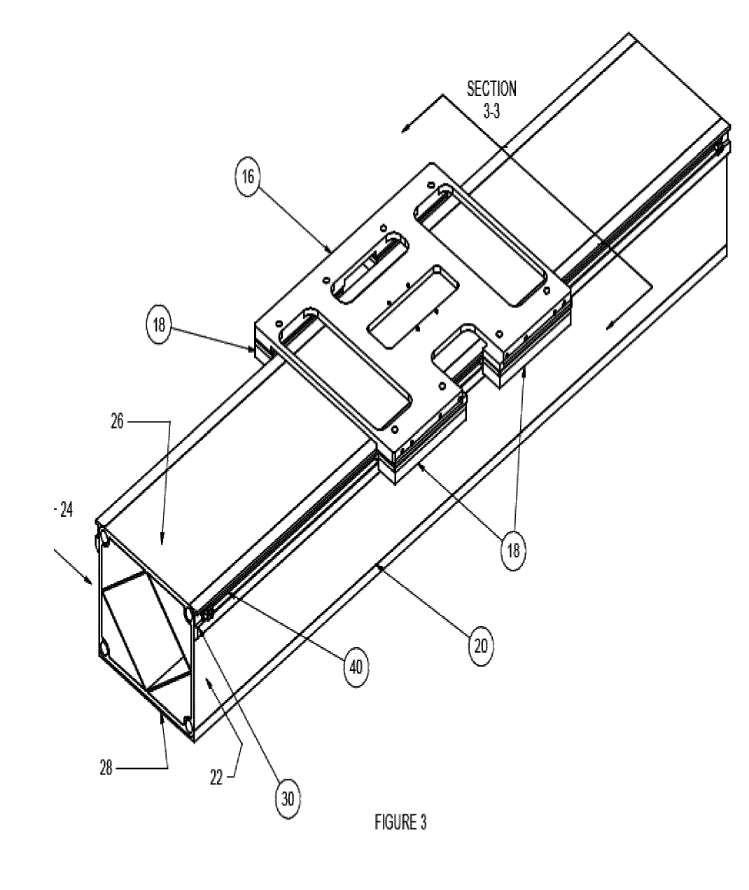

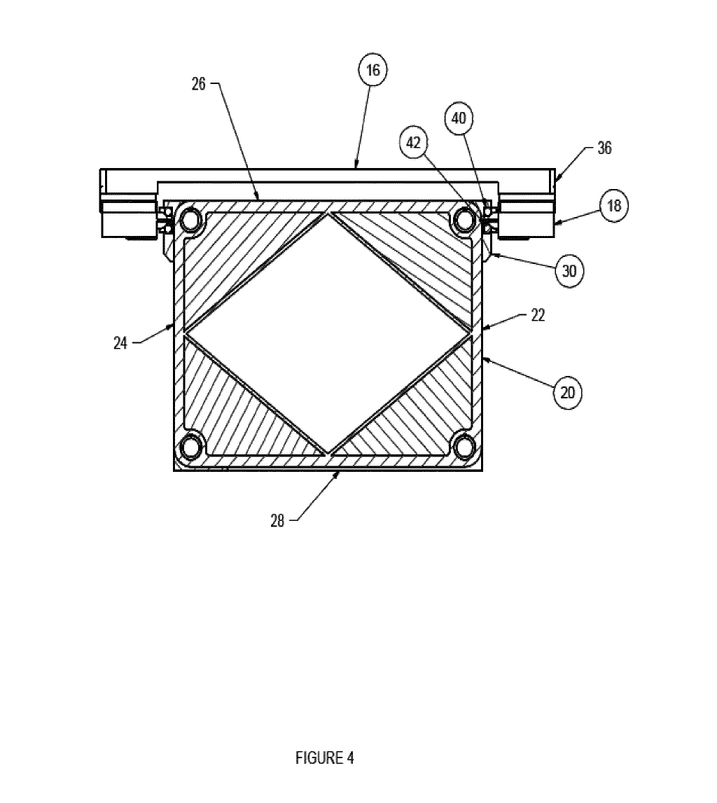

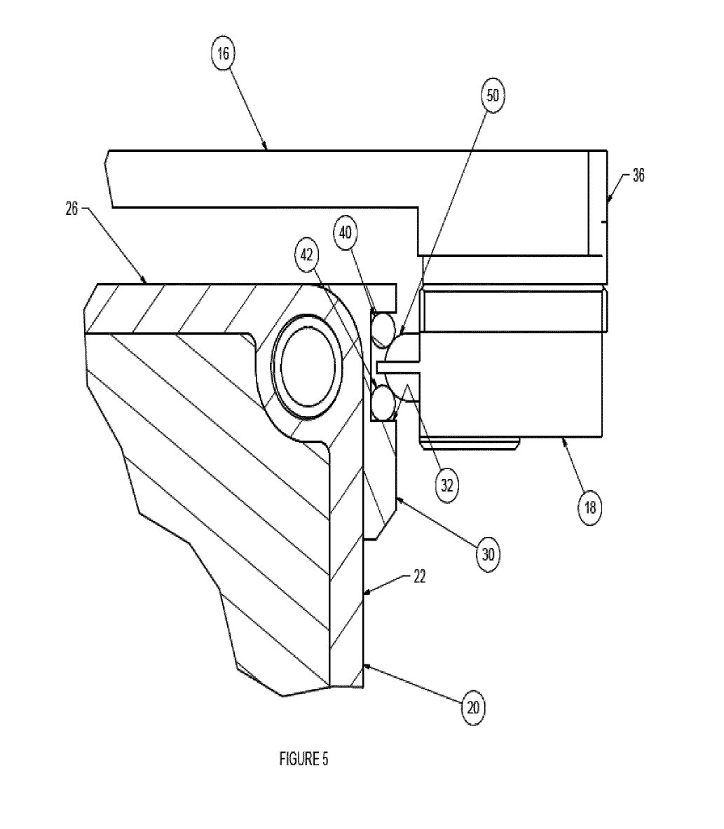

Referring now to FIG. 3, a carriage 16 is supported by recirculating ball bearing units 18 on an upper surface of a composite beam 20. The beam 20 is preferably made from composite material such as carbon fiber characterized by a first coefficient of thermal expansion. The beam 20, shown in cross-section in FIG. 4, has a generally rectangular cross-section described by side walls 22, 24 and upper and lower surfaces 26 and 28. FIG. 5 is an enlarged fragment of the upper right-hand corner of the arrangement of FIG. 4 showing a boss 30 extending along an upper portion of the sidewall 22 of the beam. A generally rectangular groove or rod way 32 is formed in boss 30 and extends along the length of the beam 20. While the groove is shown formed in boss 30 it could be formed directly in the surface of the beam, in which case the sidewall 22 would preferably be thicker.

Preferably boss 30 is formed from material having a coefficient of thermal expansion that is essentially the same as that of beam 20. Most preferably, boss 30 is formed from the same material as beam 20. While a separate boss is illustrated, it should be understood that the composite beam may be formed with an integral structure for receiving or attaching a bearing race.

A carriage 16 is slidably disposed on beam 20. Carriage 16 preferably has a reinforced edge portion 36 extending in the longitudinal direction of beam 20 to which recirculating ball bearing units 18 are mounted.

A pair of rods 40, 42 or rod ways preferably hardened steel rods is disposed in the groove 32. Preferably, the rods have at least a partially circular cross section and have a diameter less than half the width of the groove so as to form a space between the rods. A bearing element 50 or plurality of bearing elements of the recirculating ball bearing unit 18 engages the rods. An advantage of the arrangement of this invention is that it accommodates existing recirculating bearings. For example, bearings made by Schneeberger Linear Technology such as the models SK and SR bearings can be used.

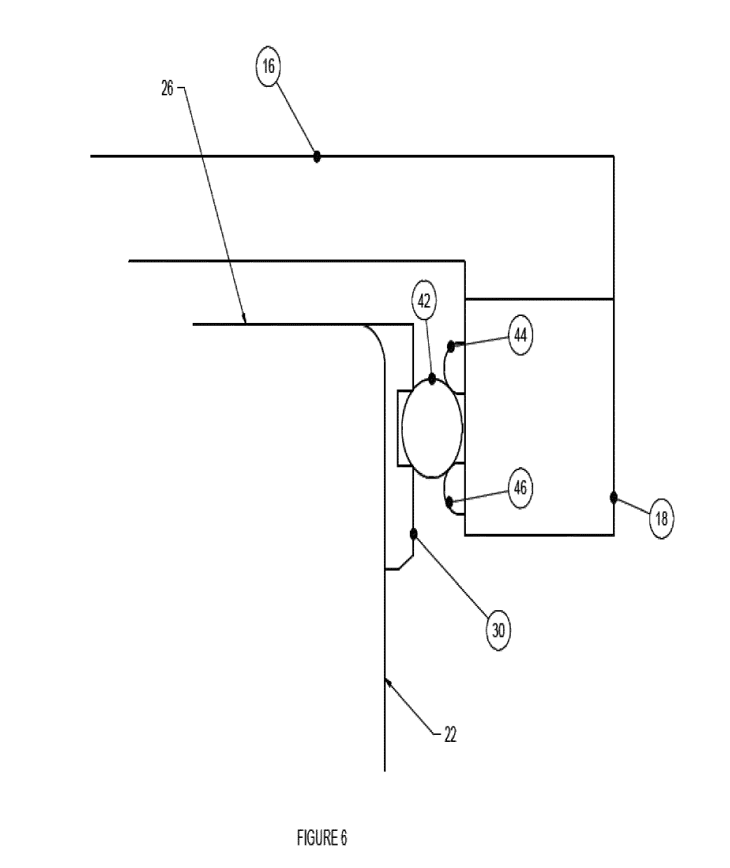

FIG. 6 shows another embodiment of the invention in which a large rod 42, again preferably a hardened steel rod is positioned in the groove and the recirculating bearing unit 18 has two rows of ball bearings 44, 46 that engage the rod.

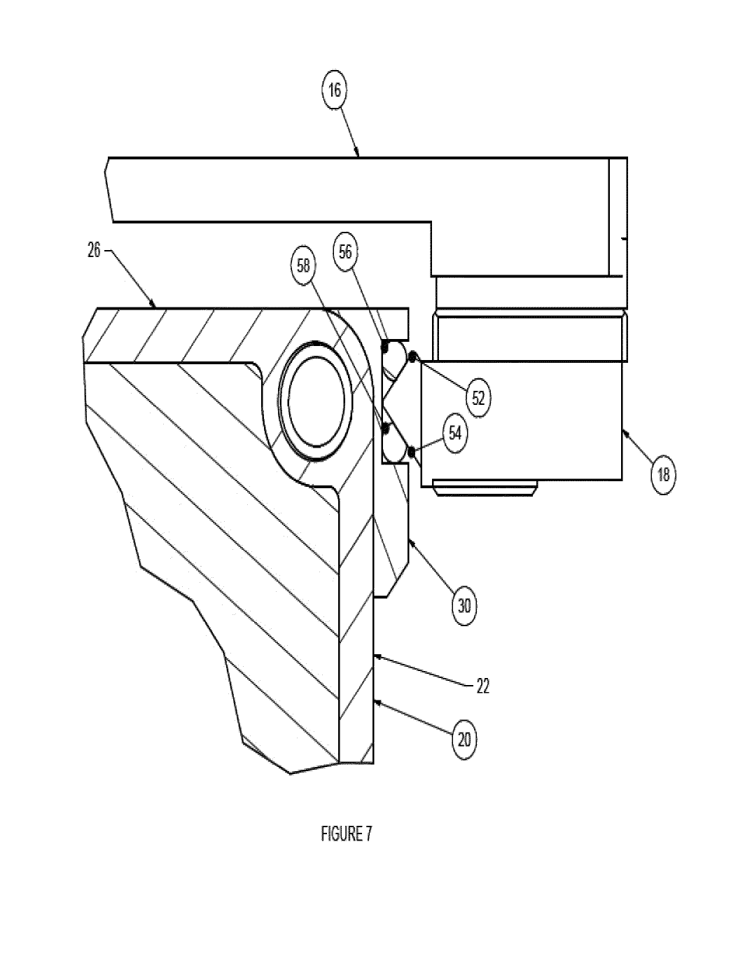

FIG. 7 shows yet another embodiment in which the recirculating ball bearing unit comprises two rows of rollers 52, 54 and the steel rods 56, 58 are ground with a flat surface for engaging the rollers.

The rod or rods shown in the figures are attached to the composite beam in a manner that permits them to expand and contract longitudinally without creating stress on the beam. Loosely fitting or lightly spring-loaded clips on each end of the rod or rods that do not constrain the length of the rod or rods from changing but prevent the rods from moving out of the rod ways are preferable. This permits the rods to thermally expand while remaining retained in the grooves or rod ways.

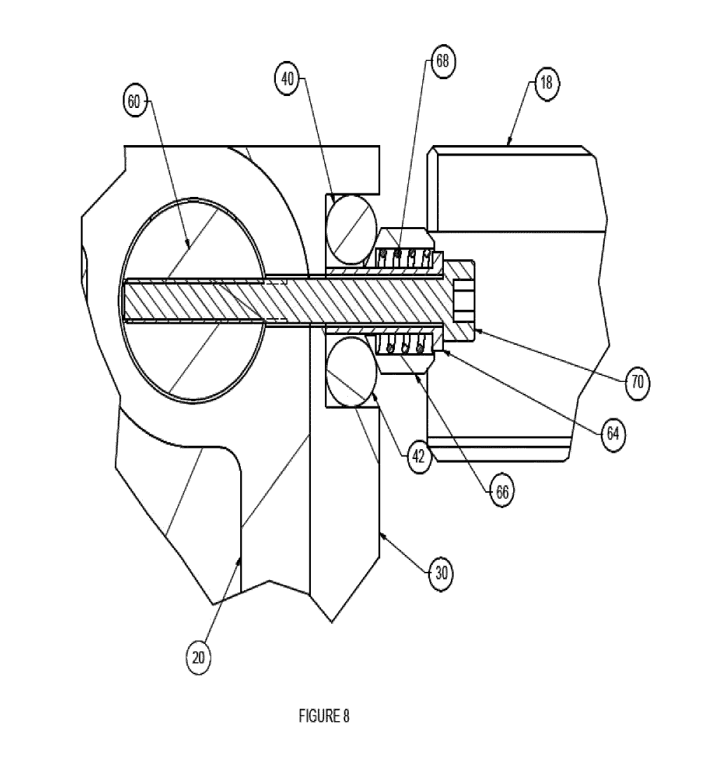

FIG. 8 shows an example of such an arrangement. An elongated bolt 70 extends through boss 30 and the corner portion of the beam 20 into a longitudinally extending anchor 60 in which a recess is threaded. A sleeve 64 is arranged on the bolt 70 and is captured between the bolt head and the base of the groove formed in the beam limiting the extent to which the bolt penetrates the anchor. A spring 68 disposed between a tapered retainer 66 and sleeve 64 urges retainer 66 into contact with the rods 40 and 42.

Referring back to FIG. 3 it can be seen that the beam has two outwardly facing channels on opposite side surfaces thereof each holding two rods or sets of rods and engaging two recirculating ball bearing units.

Any of the arrangements shown in FIGS. 5 through 7 may be used and in fact the two arrangements need not be the same.

While the invention has been described in connection with several presently preferred embodiments thereof, those skilled in the art will recognize that many modifications and changes may be made therein without departing from the true spirit and scope of the invention, which accordingly is intended to be defined solely by the appended claims.

1. A bearing race having a first coefficient of thermal expansion (COT) on a composite structure characterized by a second, different coefficient of thermal expansion (COT) comprising:
a recess formed in a surface of the composite structure;
at least one bearing race element disposed in the recess, the bearing race element characterized by a COT different from the COT of the composite structure;
a retainer securing the bearing race element in the recess and allowing for longitudinal thermal expansion of the bearing race element without creating any stress on the composite structure.

2. The bearing race of claim 1 in which the recess comprises a longitudinal recess.

3. The bearing race of claim 2 in which the recess has a width.

4. The bearing race of claim 1 in which the bearing race element comprises a pair of parallel rods.

5. The bearing race of claim 3 in which the bearing race element comprises a pair of parallel rods.

6. The bearing race of claim 5 in which the pair of parallel rods comprises a pair of rods having a generally circular cross section.

7. The bearing race of claim 5 in which the pair of parallel rods comprises a pair of rods having a flat surface.

8. The bearing race of claim 6 in which each of the parallel rods has a diameter less than half the width of the recess.

9. The bearing race of claim 1 in which the bearing race element comprises a single rod.

10. The bearing race of claim 9 in which the single rod comprises a rod having a generally circular cross section.

11. A movable stage for a measuring instrument comprising:
a carriage having a bearing element extending therefrom:
a beam having a first coefficient of thermal expansion:
a mounting area formed on the beam;
a bearing race having a second coefficient of thermal expansion
a retainer securing the bearing race in the recess and allowing for longitudinal thermal expansion of the bearing race without creating stress on the composite structure.

12. The bearing race of claim 11 in which the recess comprises a longitudinal recess.

13. The bearing race of claim 12 in which the recess has a width.

14. The bearing race of claim 11 in which the recess comprises a longitudinal recess.

15. The bearing race of claim 14 in which the recess has a width.

16. The bearing race of claim 11 in which the bearing race element comprises a pair of parallel rods.

17. The bearing race of claim 14 in which the bearing race element comprises a pair of parallel rods.

18. The bearing race of claim 17 in which the pair of parallel rods comprises a pair of rods having a generally circular cross section.

19. The bearing race of claim 17 in which the pair of parallel rods comprises a pair of rods having a flat surface.

20. The bearing race of claim 18 in which each of the parallel rods has a diameter less than half the width of the recess.

21. The bearing race of claim 11 in which the bearing race element comprises a single rod.

22. The bearing race of claim 21 in which the single rod comprises rod having a generally circular cross section.
